(19) United States
(12) Patent Application Publication
(10) Pub. No.: US 2014/0133200 A1
(43) Pub. Date: May 15, 2014

(54) CLAMP SNUBBER CIRCUIT AND RESISTANCE ADJUSTMENT METHOD FOR THE SAME

(71) Applicant: DELTA ELECTRONICS, INC., Taoyuan Hsien (TW)

(72) Inventors: Liping Sun, Taoyuan Hsien (TW); Chao Yan, Taoyuan Hsien (TW); Yiqing Ye, Taoyuan Hsien (TW)

(73) Assignee: DELTA ELECTRONICS, INC., Taoyuan Hsien (TW)

(21) Appl. No.: 13/836,691

(22) Filed: Mar. 15, 2013

(30) Foreign Application Priority Data
Nov. 14, 2012 (TW) 201210459081.2

(51) Int. Cl. H02M 1/34

(52) U.S. Cl. CPC H02M 1/34
USPC 363/50

(57) ABSTRACT

A clamp snubber circuit for reducing a value of a peak voltage on a power switch of a power converter includes: a clamp switch; a clamp capacitor having a first terminal electrically coupled to the power switch via the clamp switch, and a second terminal electrically coupled to a ground; and at least one resistance adjustment circuit, each of which includes: a switch element having a first terminal electrically coupled to the first terminal of the clamp capacitor, a second terminal electrically coupled to the ground, and a control terminal; and a control circuit configured to receive a detection parameter of the power converter and compare the detection parameter with a preset parameter and output a control signal to the control terminal of the switch element to adjust a resistance value of the resistance adjustment circuit. Peak voltages applied on power switches may be clamped and absorbed more effectively.

### CROSS-REFERENCE TO RELATED APPLICATIONS

This application claims benefits of Chinese Patent Application No. 201210459081.2, filed on Nov. 14, 2012 in the State Intellectual Property Office of China, the disclosure of which is incorporated herein by reference in its entirety.

### TECHNICAL FIELD

The present application relates to a clamp snubber circuit and a resistance adjustment method for the same in the power converter field.

### BACKGROUND

When power switches in a power converter, such as transistor and Metal Oxide Semiconductor Field Effect Transistor (MOSFET), operate in a high frequency turn-on/turn-off process, the current in the circuit experiences a large rate of change and flows through inductive elements, resulting in appearance of a peak voltage exceeding a withstanding voltage value of the power switch. The peak voltages are applied on the power switches and cause breakdown or damage of the power switches. This is a common problem existing in power converters, and this problem becomes more severe as operating current and operating frequency of the power converters increase.

By employing a clamp snubber circuit in a power converter, the peak voltage applied on the power switches in the power converter may be reduced. Generally, a power switch with a lower withstanding voltage level has a smaller on-resistance. Thus, choosing power switches with a smaller withstanding voltage level may reduce the loss and cost of the power switches. However, the clamp snubber circuit itself may bring additional losses.

For example, FIG. 1 is a circuit diagram in the prior art illustratively showing a synchronous rectifying circuit at a secondary output side of a power converter commonly used in a low voltage and large current condition and a clamp snubber circuit of the synchronous rectifying circuit. As shown in FIG. 1, a double-output-winding transformer T1, synchronous rectifying elements Q1 and Q2 serving as power switches, diodes in inverse parallel connection with Q1 and Q2, a filter capacitor C₀, and a load resistor R₀ construct a synchronous rectifying circuit at the secondary output side of the power converter. Black spots “•” near the double-output-winding transformer T1 indicate dotted terminals of the windings, and a plus sign “+” near the filter capacitor C₀ indicates a positive terminal of the output side of the power converter. Clamp diodes D1 and D2, clamp capacitors C1 and C2, and leakage resistors R1 and R2 respectively construct two RCD (resistor-capacitor-diode) clamp snubber circuits. At the moment when the synchronous rectifying elements Q1 and Q2 are turned off, the energy in a leakage inductance of windings of the double-output-winding transformer T1 and in parasitic inductance in the circuit generates peak voltages applied between source electrodes and drain electrodes of the synchronous rectifying elements. Without the snubber circuit, the synchronous rectifying elements Q1 and Q2 can be easily broken down or damaged by the generated peak voltages. Since the current at the output side of the power converter is usually large, MOSFETs with a lower withstanding voltage and a smaller on-resistance may be chosen as the synchronous rectifying elements Q1 and Q2 as far as possible. In this way, the role of the clamp snubber circuit in the power converter becomes more prominent.

The clamp snubber circuit as shown in FIG. 1 is a conventional RCD clamp snubber circuit. As shown in the broken-line frame, the upper RCD clamp snubber circuit 1 in this figure is constructed by the clamp diode D1, the clamp capacitor C1 and the leakage resistor R1. At the moment when the synchronous rectifying element Q1 is turned off, the clamp capacitor C1 absorbs the energy in the leakage inductance of the secondary winding and the parasitic inductance in the circuit so as to suppress or reduce the peak voltage applied on the synchronous rectifying element Q1. Ultra fast recovery diodes are usually chosen as the clamp diodes. Before the next turn-off moment, the clamp capacitor C1 discharges through the leakage resistor R1 to make the voltage across the clamp capacitor C1 drop to a balance state till the next moment when the synchronous rectifying element Q1 is turned off and the generated peak voltage again charges the clamp capacitor C1. Similarly, the RCD clamp snubber circuit as shown in the lower broken-line frame in this figure is constructed by the clamp diode D2, the clamp capacitor C2 and the leakage resistor R2, and has the same operation procedure as the upper RCD clamp snubber circuit 1 in this figure so as to suppress the peak voltage applied on the synchronous rectifying element Q2.

However, in such RCD clamp snubber circuits in the prior art as shown in FIG. 1, leaking charges from the clamp capacitor usually results in an energy loss. For example, the peak current leaked from the clamp capacitor flowing through the leakage resistor results in a loss, and meanwhile the steady voltage across the clamp capacitor being applied on a resistor also results in a loss, thereby influencing the efficiency of the power converter. Thus, the clamp snubber circuit in the prior art needs further improvement so as to more effectively clamp and absorb the peak voltages applied on the power switches, to further increase the efficiency of the power converter, and to further reduce the cost of the power converter.

### SUMMARY OF THE INVENTION

In order to solve at least one of the above problems, in a first aspect of the application, a clamp snubber circuit is disclosed which can reduce a value of a peak voltage on a power switch of a power converter. The clamp snubber circuit includes: a clamp switch; a clamp capacitor having a first terminal electrically coupled to the power switch via the clamp switch, and a second terminal electrically coupled to a ground; and at least one resistance adjustment circuit, each of which includes: a switch element having a first terminal electrically coupled to the first terminal of the clamp capacitor, a second terminal electrically coupled to the ground, and a control terminal; and a control circuit configured to receive a detection parameter of the power converter and compare the detection parameter with a preset parameter and output a control signal to the control terminal of the switch element to adjust a resistance value of the resistance adjustment circuit.

In a second aspect of the application, a resistance adjustment method using the above clamp snubber circuit is disclosed. The method includes: receiving a detection parameter of the power converter; comparing the detection parameter with a preset parameter and outputting a control signal; and adjusting a resistance value of the resistance adjustment circuit according to the control signal.

The technical solutions of the present application in part are capable of realizing a flexible control according to operation states of the power converter, effectively clamping and absorbing the peak voltages on the power switches of the power converter, and optimizing the efficiency of the power converter according to different operation states of the power converter as well, and reducing the loss of the clamp snubber circuit, and thus increasing the efficiency of the power converter and reducing the cost of the power converter.

### BRIEF DESCRIPTION OF THE DRAWINGS

Embodiments of the present application will be described below with reference to the appended drawings, wherein:

FIG. 1 is a circuit diagram in the prior art illustratively showing a synchronous rectifying circuit at a secondary output side of a power converter commonly used in a low voltage and large current condition and a clamp snubber circuit of the synchronous rectifying circuit;

FIG. 2 is a circuit diagram illustratively showing a synchronous rectifying circuit at a secondary output side of a power converter and a clamp snubber circuit according to an embodiment of the present application;

FIG. 3 illustratively shows a circuit diagram obtained by abstracting the clamp snubber circuit (with a clamp switch D1 omitted) in FIG. 2 into that only including a clamp capacitor C1, a resistance adjustment circuit 20 and a Direct Current (DC) voltage source E1;

FIG. 4 illustratively shows a circuit diagram obtained by deforming the circuit in FIG. 3;

FIG. 5 illustratively shows a circuit diagram of a charge leakage circuit including an resistance adjustment circuit 20 according to an embodiment of the present application;

FIG. 6 illustratively shows a circuit diagram of a closed-loop voltage control circuit for controlling the voltage of the clamp capacitor realized by an amplifier, according to an embodiment of the present application;

FIG. 7 illustratively shows a circuit diagram of a resistance adjustment circuit network which includes multiple stages of resistance adjustment circuit according to an embodiment of the present application;

FIG. 8 is a circuit diagram illustratively showing a synchronous rectifying circuit at a secondary output side of a power converter and a clamp snubber circuit according to another embodiment of the present application;

FIG. 9 illustratively shows a peak voltage Vp1 and a minimum voltage Vm1 across the clamp capacitor C1 in the case where a switch element Q502 in FIG. 8 is not conducted;

FIG. 10 illustratively shows a peak voltage Vp2 and a minimum voltage Vm2 across the clamp capacitor C1 in the case where the switch element Q502 in FIG. 8 is conducted; and

FIG. 11 is a circuit diagram illustratively showing a Flyback power converter and a clamp snubber circuit according to another embodiment of the present application.

### DESCRIPTION OF THE EMBODIMENTS

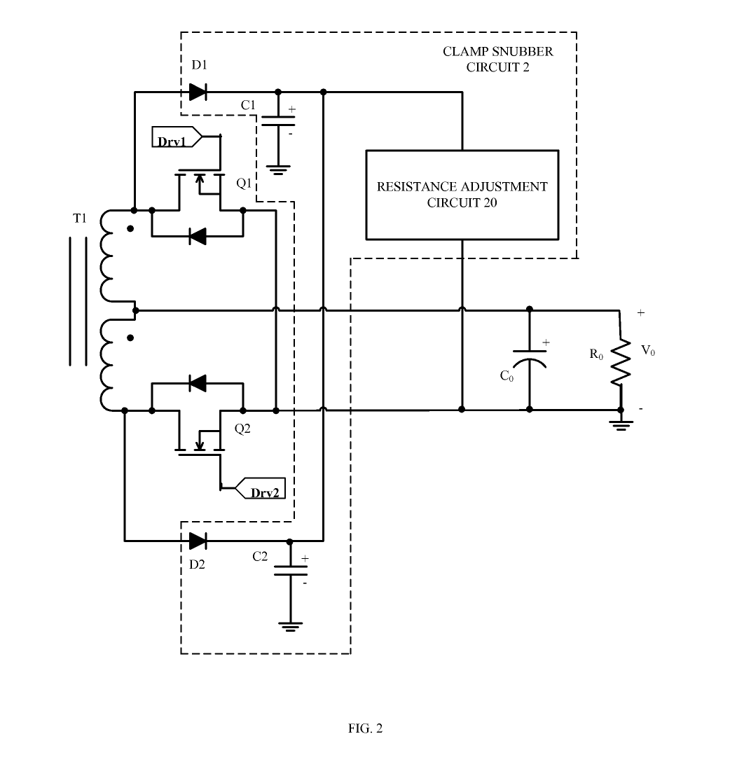

The present application will be described in detail with reference to FIGS. 2-11. It should be noted that, through the drawings of the present application described below, elements in the system with the same reference signs have the same functions; if there is a crossing between line segments serving as connection wires, the crossing labeled with a black spot “•” indicates that the crossing is a connection point, and the crossing without a black spot “•” indicates that the crossing is not a connection point and these line segments only cross over each other; turns of respective coils are only for illustration purposes, but not indicate actual value of turns or turns ratio; the reference signs of respective inductors, transformer coils and capacitors not only indicate these elements themselves, but also indicate algebraic signs indicating the volume of these elements.

FIG. 2 is a circuit diagram illustratively showing a synchronous rectifying circuit at a secondary output side of a power converter and a clamp snubber circuit according to an embodiment of the present application.

As shown in FIG. 2, a double-output-winding transformer T1, synchronous rectifying elements Q1 and Q2 (such as MOSFETs) serving as power switches, diodes in inverse parallel connection with Q1 and Q2, a filter capacitor C₀ and a load resistor R₀ construct the synchronous rectifying circuit at the secondary output side of the power converter. A clamp diode D1 and a clamp diode D2 serving as clamp switches, a clamp capacitor C1 and a clamp capacitor C2, and a resistance adjustment circuit 20 construct a clamp snubber circuit 2 as shown in a broken-line frame. Elements serving as the clamp switches are not limited to diodes, other switch devices such as transistors may also be employed. A plus sign “+” and a minus sign “−” labeled on the clamp capacitor C1 only indicate a voltage direction of the clamp capacitor C1 but not indicate a positive terminal and a negative terminal of the clamp capacitor C1. The clamp capacitor C1 may be a capacitor with polarity, or a capacitor without polarity.

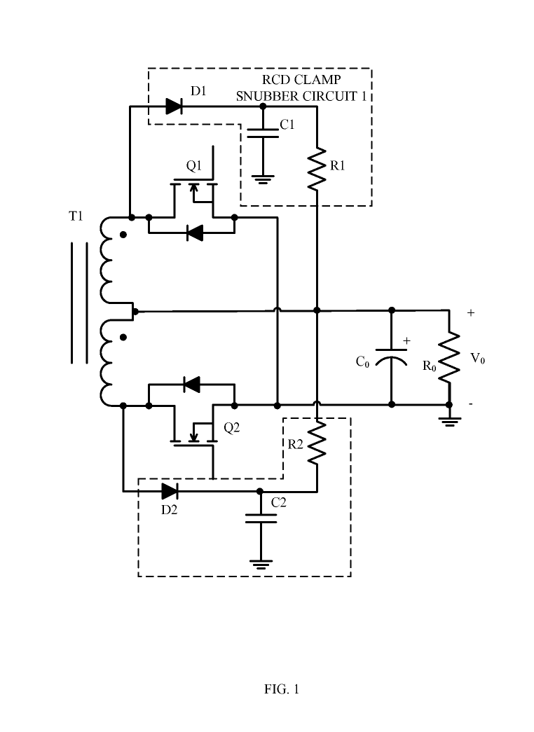

For sake of simplicity in description, the synchronous rectifying circuit at the secondary output side of the power converter in FIG. 2 has substantially the same circuit structure and reference signs as that in FIG. 1. In addition, the reference signs Drv1 and Drv2 in FIG. 2 respectively indicate driving signals required to be applied for normal operation of the synchronous rectifying elements Q1 and Q2, and thus detailed description thereof is not necessary.

In addition to using the resistance adjustment circuit 20 in FIG. 2 to replace the leakage resistor R1 in FIG. 1, the differences between the clamp snubber circuit 2 in FIG. 2 and the RCD clamp snubber circuit 1 in FIG. 1 further reside in that only one clamp snubber circuit 2 is used in FIG. 2 to clamp and absorb the peak voltages applied on the two synchronous rectifying elements Q1 and Q2. Thus, the clamp snubber circuit 2 in FIG. 2 may also be considered to further include the clamping diode D2 serving as a clamp switch and the clamp capacitor C2. However, since the clamp diode D2 and the clamp capacitor C2 are respectively located at symmetry positions in the circuit with the clamp diode D1 and the clamp capacitor C1 and they have the same operation procedure, related descriptions regarding the procedure of the clamp diode D2 and the clamp capacitor C2 are omitted when the clamp snubber circuit 2 is described below in detail for sake of simplicity in description.

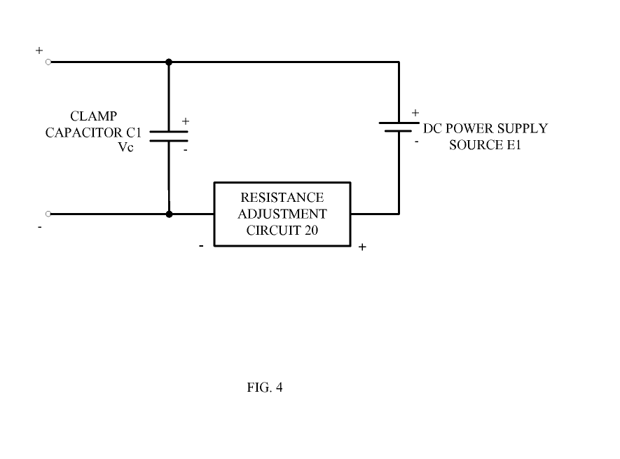

As shown in FIG. 2, the clamp snubber circuit 2 of the present application includes the clamp diode D1 serving as a clamp switch, the clamp capacitor C1 and the resistance adjustment circuit 20. The resistance adjustment circuit 20 includes a switch element and a control circuit. The configuration of the resistance adjustment circuit 20 will be further described in detail after FIG. 4. An anode of the clamp diode D1 is connected to a terminal, which is connected with the synchronous rectifying element Q1, of a winding of the double-output-winding transformer T1 in the synchronous rectifying circuit at the secondary output side of the power converter, i.e., the anode of the clamp diode D1 is connected to a node in the power converter where a peak voltage needs to be absorbed. The cathode of the clamp diode D1 is connected to a first terminal of the clamp capacitor C1. A second terminal of the clamp capacitor C1 is electrically coupled to a ground, or electrically coupled to the ground via a second power supply which may be a bus voltage across a bus capacitor or may be an output voltage of the power converter. A control terminal of the switch element in the resistance adjustment circuit 20 is connected to the control circuit. A connection node of the cathode of the clamp diode D1 and the first terminal of the clamp capacitor C1 is connected to a first terminal of the switch element in the resistance adjustment circuit 20. A second terminal of the switch element is also electrically coupled to the ground or electrically coupled to the ground via a first power supply, or may be connected to the second terminal of the clamp capacitor C1 and then electrically coupled to the ground via the second power supply, i.e., the first power supply may be a voltage source having a lower voltage potential than the voltage potential of the clamp capacitor C1, or may be the output voltage V₀ of the power converter. That is to say, the resistance adjustment circuit 20 may be connected in series with a resistor or a voltage source and then connected with the clamp capacitor C1 in parallel, or the resistance adjustment circuit 20 may be directly connected with the clamp capacitor C1 in parallel.

At the moment when the synchronous rectifying element Q1 is turned off, the clamp capacitor C1 absorbs the energy in the leakage inductance of the secondary winding and the parasitic inductance in the circuit, thereby suppressing the peak voltage applied on the synchronous rectifying element Q1. Before the coming of the next turn-off moment, the clamp capacitor C1 discharges through the resistance adjustment circuit 20 to make the voltage across the clamp capacitor C1 drop to a balance state till the next moment when the synchronous rectifying element Q1 is turned off and the generated peak voltage again charges the clamp capacitor C1.

Similarly, the lower structure in this figure constructed by the clamp diode D2 and the clamp capacitor C2 is electrically coupled to a connection point of the first terminal of the clamp capacitor C1 and the resistance adjustment circuit 20 via the clamp capacitor C2, and has the same operation procedure as the upper structure in this figure constructed by the clamp diode D2 and the clamp capacitor C1 so as to suppress the peak voltage applied on the synchronous rectifying element Q2.

Unlike FIG. 1, in the resistance adjustment circuit 20 and the adjustment method of the present application, the resistance value of the resistance adjustment circuit is adjusted according to operation states of the power converter. That is to say, the operation states of the power converter are detected, a detection parameter (for example, an operating current or an operating frequency) is output to the control circuit of the resistance adjustment circuit, the control circuit compares the detection parameter with a preset parameter and then outputs a control signal to the control terminal of the switch element to adjust the resistance value of the resistance adjustment circuit. For example, when the output current (i.e., the operating current) or the operating frequency of the power converter is larger than a preset parameter, the resistance value of the resistance adjustment circuit 20 is reduced; when the operating current or the operating frequency of the power converter is less than the preset parameter, the resistance value of the resistance adjustment circuit 20 is increased; thus, the power converter is capable of effectively clamping and absorbing the peak voltages applied on the synchronous rectifying elements Q1 and Q2 in any operation state. In this way, power switches (such as MOSFET) with a lower withstanding voltage level may still be chosen in the case of a large operating current or a high operating frequency, thereby reducing the cost of the power converter and meanwhile increasing the efficiency of the power converter.

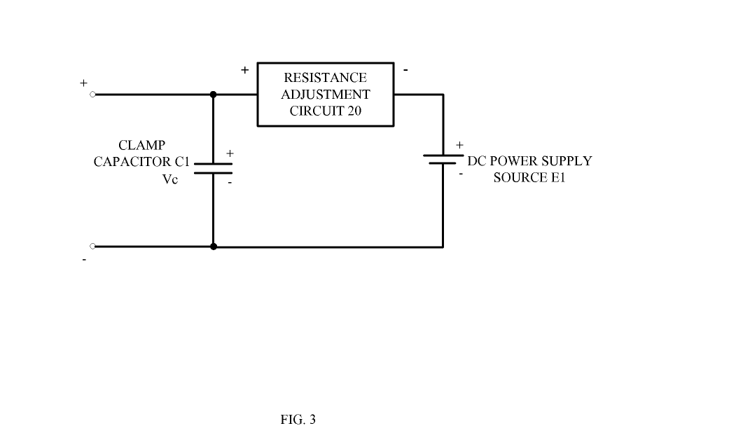

The clamp snubber circuit (with the clamp switch D1 omitted) in FIG. 2 may be abstracted into that only including a clamp capacitor C1, a resistance adjustment circuit 20, and a first power supply which for example may be a DC voltage source E1 or a resistor or a capacitor which is considered as a DC voltage source E1. The resistance adjustment circuit 20 is connected with the DC voltage source E1 in series and then connected with the clamp capacitor C1 in parallel, as shown in FIG. 3.

FIG. 3 illustratively shows a circuit diagram obtained by abstracting the clamp snubber circuit (with the clamp switch D1 omitted) in FIG. 2 into that only including a clamp capacitor C1, a resistance adjustment circuit 20 and a DC voltage source E1. As shown in FIG. 3, a positive terminal of the resistance adjustment circuit 20 is connected to a first terminal of the clamp capacitor C1, a negative terminal of the resistance adjustment circuit 20 is electrically coupled to a positive terminal of the DC voltage source E1, a negative terminal of the DC voltage source E1 is electrically coupled to a second terminal of the clamp capacitor C1. The voltage of the DC voltage source E1 may be lower than the voltage V_{c} across the clamp capacitor C1, especially may be a DC power supply having a voltage lower than the peak voltage (for example, may be the output voltage V₀ of the power converter) across the clamp capacitor C1. In this way, the charges on the clamp capacitor C1 may be effectively leaked through the resistance adjustment circuit 20, thereby reducing the voltage V_{c} across the clamp capacitor C1. “A positive terminal or a negative terminal of the resistance adjustment circuit 20” is a term provided only for the purpose of simplicity in description. Since the resistance adjustment circuit 20 belongs a DC circuit, such equivalence is available.

The connection of the circuit as shown in FIG. 3 may have a deformed form. For example, FIG. 4 illustratively shows a circuit diagram obtained by deforming the circuit in FIG. 3. As shown in FIG. 4, the negative terminal of the resistance adjustment circuit 20 is connected to the second terminal of the clamp capacitor C1, the positive terminal of the resistance adjustment circuit 20 is electrically coupled to the negative terminal of the DC voltage source E1, and the positive terminal of the DC voltage source E1 is electrically coupled to the first terminal of the clamp capacitor C1.

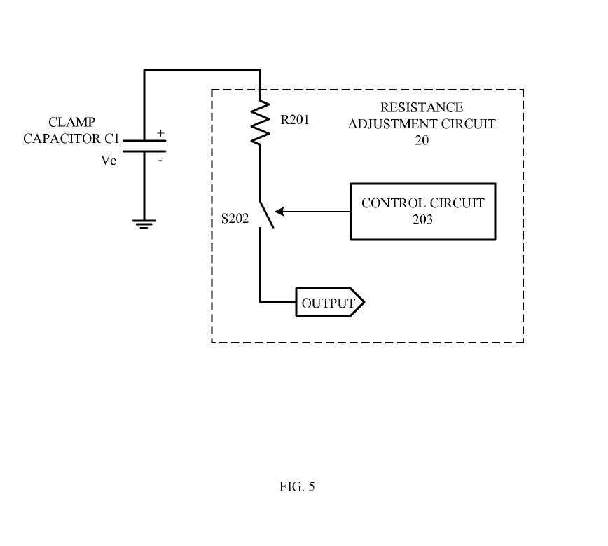

FIG. 5 illustratively shows a circuit diagram of a charge leakage circuit including a resistance adjustment circuit 20 according to an embodiment of the present application. Specifically, as shown in the broken-line frame in FIG. 5, the resistance adjustment circuit 20 of the present application may include a resistor R201, a switch element S202 and a control circuit 203. The switch element S202 may be a MOSFET, or may be other types of switch elements such as a Bipolar Junction Transistor (BJT). A first terminal of the switch element S202 is electrically coupled to the first terminal of the clamp capacitor C1, a second terminal of the switch element S202 may be electrically coupled to a ground or may be electrically coupled to a stable DC voltage source having a lower voltage potential than the voltage potential of the clamp capacitor C1, or may be electrically coupled to a resistor or a capacitor considered as a stable DC voltage source, such as the output voltage of the power converter.

As shown in FIG. 5, through the first resistor R201, the first terminal of the switch element S202 is connected with the first terminal of the clamp capacitor C1, charges on which are needed to be leaked, so as to form a charge leakage circuit of the clamp capacitor C1. It should be pointed out that, a second resistor may be connected in parallel between the first and the second terminals of the switch element S202, and the first terminal of the switch element S202 is electrically coupled to the first terminal of the clamp capacitor C1. The control circuit 203 controls the control terminal (i.e. a gate electrode) of the switch element S202 according to the operation states of the power converter, so as to change the equivalent resistance value of this charge leakage path. For example, the switch element S202 in FIG. 5 is a MOSFET, the control circuit 203 receives the detection parameter of the power converter and compares the detection parameter with a preset parameter, and then outputs a control signal to the control terminal (i.e., the gate electrode) of the switch element S202, to make the switch element S202 operate in different states, so as to enable the resistance adjustment circuit 20 to present different resistance values. For example, by making the switch element S202 operate in a turn-on state, a turn-off state, or a linear state (i.e., an amplification state), the leakage speed of the charges on the clamp capacitor C1 may be adjusted so as to effectively suppress the peak voltage across the clamp capacitor C1, i.e., the peak voltage applied on the power switch of the power converter. In this way, power switches (such as MOSFET) having a lower withstanding voltage level may still be chosen in the case of a large operating current or a high operating frequency, and meanwhile the efficiency of the power converter may be increased.

As an embodiment of the present application, if the switch element S202 operates in a linear state, the resistance value of the resistor R201 in FIG. 5 may be zero, i.e., R201 may be omitted or may be short-circuited.

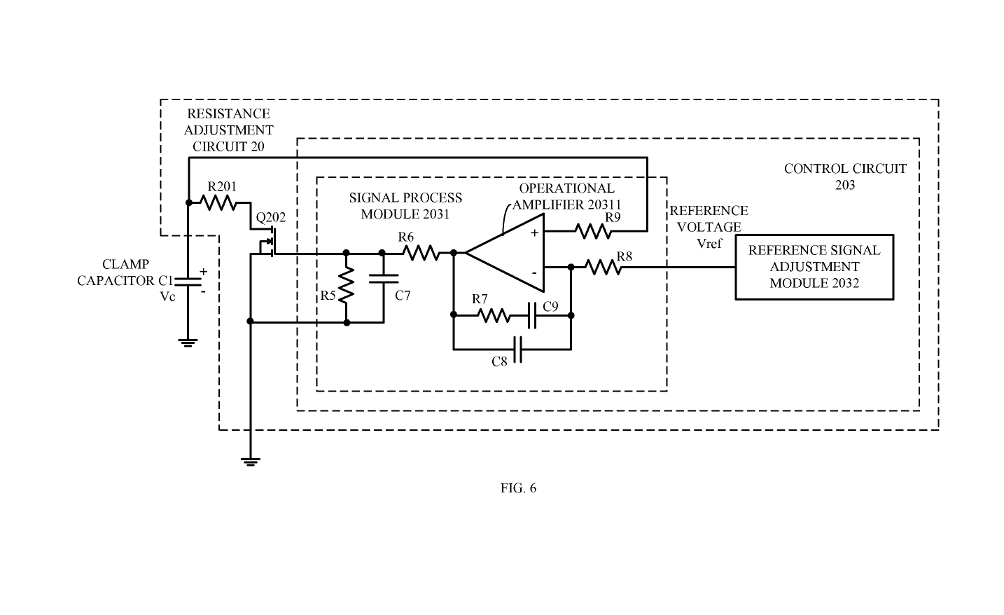

The control circuit in FIG. 5 may be realized by a digital circuit such as Digital Signal Processor (DSP) or an analog circuit. FIG. 6 illustratively shows a circuit diagram of a closed-loop voltage control circuit for controlling the voltage of the clamp capacitor realized by an amplifier, according to an embodiment of the present application. As shown in the broken-line frame in FIG. 6, the resistance adjustment circuit 20 of the present application may include a resistor R201, a switch element Q202 and a control circuit 203. A terminal of the resistor R201 may be connected with the clamp capacitor C1, and the other terminal of the resistor R201 may be connected with the switch element Q202 in series, to form a charge leakage circuit of the clamp capacitor C1, for example, to leak the charge into a ground.

The control circuit 203 according to the present application is a closed-loop voltage control circuit for controlling the voltage of the clamp capacitor, realized by an amplifier, and includes a signal process module 2031 and a reference signal adjustment module 2032. The capacitors C7, C8, C9 and the resistors R5, R6, R7, R8 and R9 and an operational amplifier 20311 together construct the signal process module 2031, and detailed description is omitted here.

As shown in FIG. 6, the reference signal adjustment module 2032 receives a detection parameter and compares the detection parameter with a preset parameter, and outputs at least a reference voltage Vref to a second input terminal of the signal process module 2031, for example, to the “−” terminal of the operational amplifier 20311 in FIG. 6. The signal process module 2031 adjusts an output voltage of the signal process module 2031 (i.e., the control voltage applied on the control terminal of the switch element Q202) by inputting a feedback voltage from the clamp capacitor C1 into a first input terminal of the signal process module 2031 (for example, the “+” terminal of the operational amplifier 20311 in FIG. 6) and performing a computation with the reference voltage Vref. The signal process module 2031 has an output terminal electrically coupled to the control terminal of the switch element Q202, and outputs a control signal to change the operation states of the switch element Q202, i.e., changing the resistance value of the resistance adjustment circuit 20. The reference signal adjustment module 2032 may adjust and provide the reverence voltage Vref according to the operation states of the power converter, so as to finally realize an adjustment on the voltage across the clamp capacitor C1.

The resistance adjustment circuit 20 employing the closed-loop voltage control circuit for controlling the voltage of the clamp capacitor in FIG. 6 may be applied in a resonant power converter, for example, an Inductor-Inductor-Capacitor (LLC) resonant power converter. When the operating frequency (i.e., the detection parameter) of the power converter is larger than a reference frequency (State 1), a first reference voltage of the closed loop is set as Vref1; when the operating frequency is less than or equal to the reference frequency (State 2), a second reference voltage of the closed loop is set as Vref2. The resistance adjustment circuit 20 employing the closed-loop voltage control circuit for controlling the voltage of the clamp capacitor in FIG. 6 may be applied in a Pulse Width Modulation (PWM) power converter such as a Phase-Shifted Full-Bridge (PSFB) power converter, a Flyback power converter, a Boost power converter, a Buck power converter, or a Forward power converter. When the operating current (i.e., the detection parameter) of the power converter is larger than a reference current (State 1), a first reference voltage of the closed loop is set as Vref1; when the operating current is less than the reference current (State 2), a second reference voltage of the closed loop is set as Vref2. Vref1<Vref2, i.e., in the case of State 1, the resistance value of the resistance adjustment circuit 20 is reduced to provide a relatively small equivalent leakage resistance, and in the case of State 2, the resistance value of the resistance adjustment circuit 20 is increased to provide a relatively large equivalent leakage resistance, so as to ensure that the equivalent resistance value of the leakage resistor in the charge leakage circuit may be adjusted according to the operation states of the switch element Q202 in the resistance adjustment circuit 20 in different operation states of the power converter. In FIG. 6, a plurality of closed-loop reference voltage values may be set, which may be set according to a plurality of reference frequencies or reference currents. That is to say, a plurality of reference frequencies or reference currents may be set as well, and different resistance values of the resistance adjustment circuit may be provided according to different reference frequencies or reference currents.

As an embodiment of the present application, if the switch element Q202 operates in a linear state, the resistance value of the resistor R201 in FIG. 6 may be zero, i.e., R201 may be omitted or may be short-circuited.

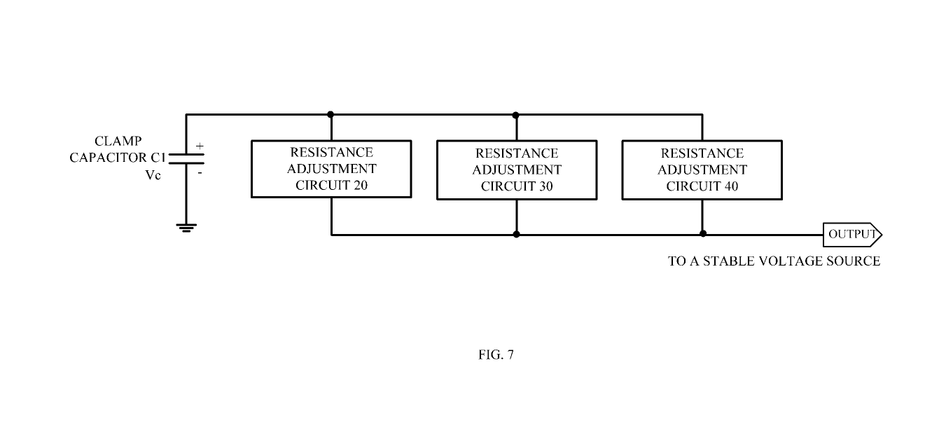

The resistance adjustment circuit of the present application may be extended from the circuit as show in FIG. 2 which only includes one stage of resistance adjustment circuit 20 to a resistance adjustment circuit network which consists of multiple stages of resistance adjustment circuits, i.e., with two or more branches of resistance adjustment circuit connected in parallel. FIG. 7 illustratively shows a circuit diagram of a resistance adjustment circuit network which includes multiple stages of resistance adjustment circuits according to an embodiment of the present application. As shown in FIG. 7, a resistance adjustment circuit 20, a resistance adjustment circuit 30 and a resistance adjustment circuit 40 are connected in parallel, so as to realize a fine resistance adjustment. It should be appreciated that, the configuration or adjustment method of each of the resistance adjustment circuit 20, the resistance adjustment circuit 30 and the resistance adjustment circuit 40 may be the same or may be different from each other. It should be noted that, the configuration of each of the resistance adjustment circuits may only include a switch element and a control circuit, or may include a switch element, a resistor and a control circuit, among which the switch element and the resistor may be connected in series or in parallel. The adjustment methods of the resistance adjustment circuits may be by adjusting the switch elements in the resistance adjustment circuits according to the operating frequency or operating current of the power converter so as to make the switch elements operate in a saturation region, an amplification region or a cut-off region. The resistance adjustment circuit network is not limited to three stages.

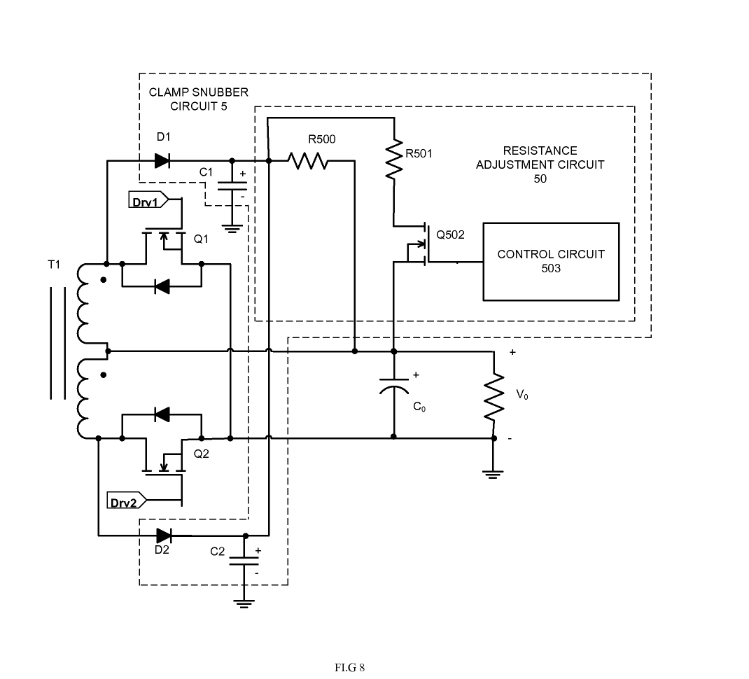

FIG. 8 is a circuit diagram illustratively showing a synchronous rectifying circuit at a secondary output side of a power converter and a clamp snubber circuit according to another embodiment of the present application. FIG. 8 is a specific embodiment of FIG. 2, and the difference between FIG. 8 and FIG. 2 resides in that the resistance adjustment circuit 20 in FIG. 2 is embodied as a resistance adjustment circuit 50 in FIG. 8. For sake of simplicity in description, the synchronous rectifying circuit at the secondary output side of the power converter in FIG. 8 has substantially the same circuit structure and reference signs as that in FIG. 2. The reference signs Drv1 and Drv2 in FIG. 8 respectively indicate driving signals required to be applied for normal operation of the synchronous rectifying elements Q1 and Q2, and thus detailed description thereof is not necessary.

The full-wave rectifying circuit at the secondary side of the power converter in FIG. 8 employs a synchronous rectifying control method which may be applied in various power converters such as a LLC resonant power converter, or may be applied in a power converter with a Phase-Shifted Full-Bridge circuit.

As shown in the broken-line frame in FIG. 8, a clamp snubber circuit 5 includes a clamp diode D1 and a clamp diode D2 serving as clamp switches, a clamp capacitor C1, a clamp capacitor C2 and a resistance adjustment circuit 50. An anode of the clamp diode D1 is connected to a connection point which connects a terminal of a winding of the double-output-winding transformer T1 in the synchronous rectifying circuit at the secondary output side of the power converter and a terminal of the synchronous rectifying element Q1, and a cathode of the clamp diode D1 is connected to a first terminal of the clamp capacitor C1. A second terminal of the clamp capacitor C1 is electrically coupled to a ground or electrically coupled to a ground via a second power supply. A connection point of the cathode of the clamp diode D1 and the first terminal of the clamp capacitor C1 is connected to a terminal of the resistance adjustment circuit 50, and the other terminal of the resistance adjustment circuit 50 may be electrically coupled to a ground or electrically coupled to a ground via a first power supply, or may be connected to the second terminal of the clamp capacitor C1 and then electrically coupled to a ground via a second power supply, i.e., the first power supply may be a voltage source having a lower voltage potential than the voltage potential of the clamp capacitor C1, for example may be the voltage across the output filter capacitor C₀ in FIG. 8, i.e., the voltage potential on the positive terminal of the output V₀ of the power converter.

The clamp diode D2 and the clamp capacitor C2 in the clamp snubber circuit 5 in FIG. 8 are respectively located at symmetry positions in the circuit with the clamp diode D1 and the clamp capacitor C1, and they have the same operation procedure. Thus, for sake of simplicity in description, related descriptions regarding the procedure of the clamp diode D2 and the clamp capacitor C2 are omitted when the clamp snubber circuit 5 is described below in detail.

As shown in the broken-line frame in FIG. 8, the resistance adjustment circuit 50 of the present application includes a second resistor R500, a first resistor R501, a switch element Q502 and a control circuit 503. A terminal of the first resistor R501 is electrically coupled to a first terminal of the clamp capacitor C1, and the other terminal of the resistor R501 is electrically coupled to a first terminal of the switch element Q502. A terminal of the second resistor R500 is electrically coupled to the first terminal of the clamp capacitor C1, and the other terminal of the second resistor R500 is electrically coupled to a second terminal of the switch element Q502. The second terminal of the switch element Q502 is connected to a positive terminal of the output V₀ of the power converter. Thus a charge leakage circuit of the clamp capacitor C1 is formed. The control circuit 503 is connected to a control terminal (i.e., a gate electrode) of the switch element Q502, so as to control the switch element Q502 according to the operation states of the power converter, to change the equivalent resistance value of this charge leakage path.

How the resistance adjustment circuit 50 of the present application operates will be described by taking a LLC resonant circuit application as an example. At the moment when the synchronous rectifying element Q1 serving as a power switch is turned off, the voltage across the clamp capacitor C1 in the clamp snubber circuit 5 is charged to a peak voltage rapidly, and meanwhile the clamp snubber circuit 5 clamps the voltage between a source electrode and a drain electrode of the synchronous rectifying element Q1 to the peak voltage. Here, an on-state voltage drop of the clamp diode D1 is omitted reasonably. Thereafter, the charges on the clamp capacitor C1 is leaked by the resistance adjustment circuit 50, the voltage across the clamp capacitor C1 drops gradually, and before the turn-off of another synchronous rectifying element Q2, it drops to a minimum voltage.

Specifically, for example, by making the switch element Q502 operate in a conduction state, a cut-off state, or a linear state (i.e., an amplification state), the leakage speed of the charges on the clamp capacitor C1 may be adjusted. That is to say, according to the operation states of the power converter, the resistance adjustment circuit 50 may present different equivalent resistance values for the clamp capacitor C1, so as to realize an effective suppression of the peak voltage across the clamp capacitor C1 and meanwhile increase the efficiency of the power converter.

Similarly, through the clamp capacitor C2, the lower structure in this figure constructed by the clamp diode D2 serving as a clamp switch and the clamp capacitor C2 is connected to a connection point of the first terminal of the clamp capacitor C1 and the resistance adjustment circuit 50, and has the same operation procedure as the upper structure in this figure constructed by the clamp diode D1 and the clamp capacitor C1, so as to suppress the peak voltage applied on the synchronous rectifying element Q2 serving as a power switch.

The magnitude of the resistance value of the resistance adjustment circuit 50 will influence the magnitude of the above peak voltage and the minimum voltage of the clamp capacitor C1, and just the magnitudes of the above peak voltage and the minimum voltage determine the selection of the withstanding voltage value of the synchronous rectifying element Q1 or Q2 serving as a power switch. Generally, a switch element with a higher withstanding voltage has a larger on-resistance, and thus the circuit thereof has a larger loss. For the resistance adjustment circuits having the same resistance values, the magnitudes of the peak voltage and the minimum voltage across the clamp capacitor C1 vary in different operation states of the power converter. Thus, in the present application, the resistance value of the resistance adjustment circuit 50 is adjusted according to different operation states of the power converter, to make the clamp snubber circuit 5 satisfy the requirement of suppressing the peak voltage on the synchronous rectifying element Q1 (Q2), and meanwhile to make the equivalent resistance value of the resistance adjustment circuit 50 be maximized so as to minimize the loss caused by the clamp snubber circuit 50.

For example, when the rectifying element Q1 (Q2) serving as a power switch has a relatively small operating current or is turned off in a zero current state, i.e., when the current needed to be leaked by the resistance adjustment circuit 50 is relatively small, the clamp capacitor C1 (C2) can make the voltage V_{c} across the clamp capacitor C1 (C2) be stabilized within a range only by discharging through the second resistor R500, and thus the loss caused by the clamp snubber circuit 5 may be relatively small. However, when the power converter has a relatively large operating current, i.e., when the current that needs to be leaked by the resistance adjustment circuit 50 is relatively large, if it is not controlled by the switch element Q502 to reduce the equivalent resistance value of the charge leakage circuit of the clamp capacitor C1 (C2), a quite high peak voltage will be generated on the clamp capacitor C1 (C2) and the synchronous rectifying element Q1 (Q2), and thus the withstanding voltage level of the synchronous rectifying element Q1 (Q2) has to be elevated, thereby imposing adverse influence on the cost and operation efficiency of the power converter.

As an embodiment of the present application, if the switch element Q502 operates in a linear state, the resistance value of the first resistor R501 in FIG. 8 may be zero, i.e., the first resistor R501 may be omitted or may be short-circuited, and thus the charge leakage circuit of the clamp capacitor C1 (C2) may be considered as being formed only by the parallel connection of the second resistor R500 and the switch element Q502.

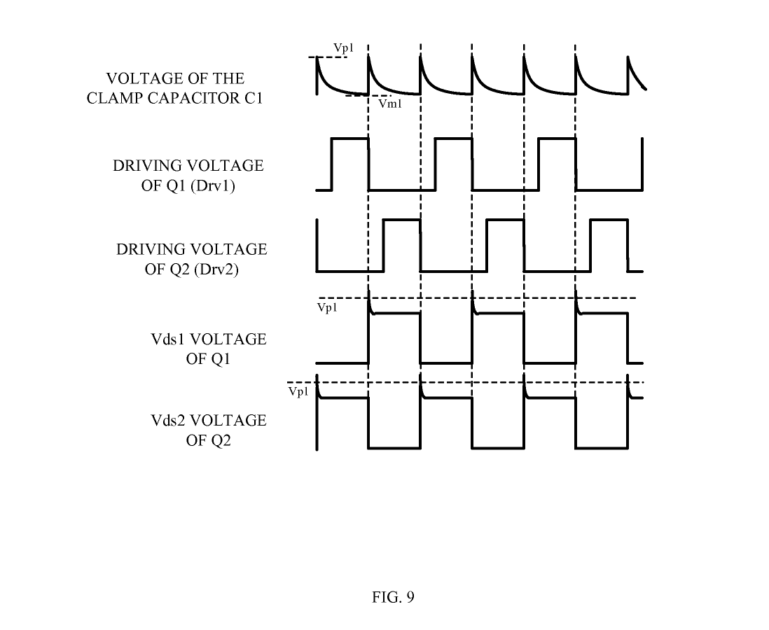

FIG. 9 illustratively shows a peak voltage Vp1 and a minimum voltage Vm1 across the clamp capacitor C1 in the case where the switch element Q502 in FIG. 8 is not conducted. FIG. 9 also shows a waveform sequence diagram of a driving voltage of the synchronous rectifying element Q1 (Drv1), a waveform sequence diagram of a driving voltage of the synchronous rectifying element Q2 (Drv2), a waveform sequence diagram of a voltage Vds1 between a source electrode and a drain electrode of the synchronous rectifying element Q1, and a waveform sequence diagram of a voltage Vds2 between a source electrode and a drain electrode of the switch transistor Q2. The waveform sequence diagram of the driving voltage (Drv1) ((Drv2)) of the synchronous rectifying element Q1 (Q2) depends on application requirements of the circuit, and the waveform sequence diagram of the voltage Vds1 (Vds2) between the source electrode and the drain electrode of the synchronous rectifying element Q1 (Q2) reflects a voltage value withstood by the source electrode and the drain electrode of Q1 (Q2) at the moment when the synchronous rectifying element Q1 (Q2) is turned off.

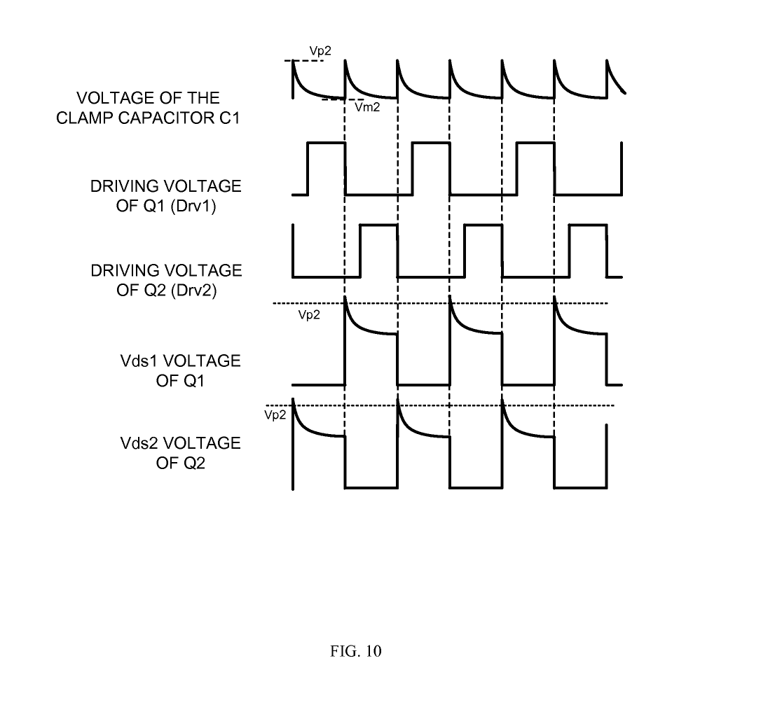

FIG. 10 illustratively shows a peak voltage Vp2 and a minimum voltage Vm2 across the clamp capacitor C1 in the case where the switch element Q502 in FIG. 8 is conducted. As shown in FIG. 8, the switch element Q502 and the first resistor R501 are connected with each other in series, and a terminal of the first resistor R501 is connected to a connection point of a first terminal of the clamp capacitor C1 and a terminal of the second resistor R500, and a second terminal of the switch element Q502 is connected to the other terminal of the second resistor R500. By the conduction of the switch element Q502, the resistance value of the resistance adjustment circuit 50 may be reduced, so as to make the voltage across the clamp capacitor C1 (C2) be discharged to the voltage Vm2 less than Vm1 before the next moment when the synchronous rectifying element Q1 (Q2) is turned off, and meanwhile to make peak voltage across the clamp capacitor C1 (C2) be reduced to Vp2. After the conduction of the switch element Q502, the peak voltage and the minimum voltage across the clamp capacitor C1 (C2) drops at the same time so that the clamp function on the voltage Vds1 (Vds2) between the source electrode and the drain electrode of the synchronous rectifying element Q1 (Q2) can be realized better. In this way, power switches (such as MOSFET) with a lower withstanding voltage level may still be chosen in the case of an increased operating current or an raised operating frequency of the synchronous rectifying element Q1 (Q2), thereby increasing the efficiency of the power converter and reducing the cost of the power converter as a whole.

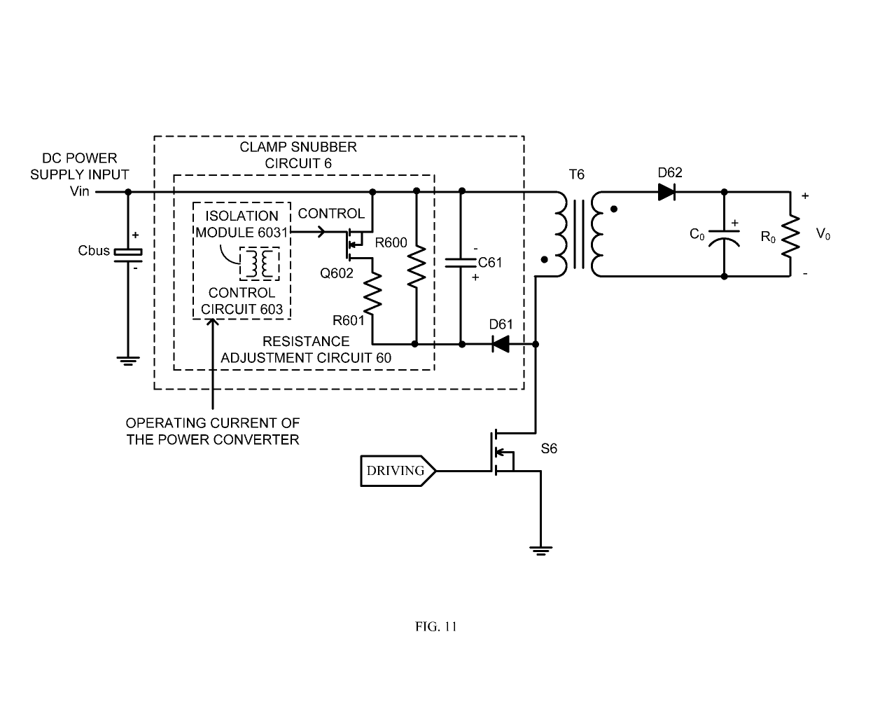

FIG. 11 is a circuit diagram illustratively showing a Flyback power converter and a clamp snubber circuit according to another embodiment of the present application. As shown in FIG. 11, a primary side of a transformer T6 is connected with a power switch S6 (such as a MOSFET) in series so as to transfer electrical energy provided by a DC power supply input Vin to a secondary side of the transformer T6 by the switching action of the power switch S6. The electrical energy experiences rectification by a rectifying diode D62 and filtering by a filter capacitor C₀ and then serves as a DC output V₀ of the Flyback power converter. Cbus is a filter capacitor of the DC power supply input Vin, the plus sign “+” indicates a positive terminal of the power supply, and the minus sign “−” indicates a negative terminal of the power supply. A driving signal is applied on a control terminal of the power switch S6 to control the output voltage and power of the Flyback power converter.

As shown in the broken-line frame in FIG. 11, a clamp snubber circuit 6 of the present application includes a clamp diode D61 serving as a clamp switch, a clamp capacitor C61 and a resistance adjustment circuit 60. An anode of the clamp diode D61 is connected to a connection point which connects a terminal of a primary winding at the primary side of the transformer T6 in the Flyback power converter and the power switch S6, and a cathode of the clamp diode D61 is connected to a first terminal of the clamp capacitor C61. A second terminal of the clamp capacitor C61 is electrically coupled to a second power supply, for example, the voltage input to the filter capacitor Cbus in FIG. 11 (i.e., the positive terminal of the DC power supply input Vin of the Flyback power converter), and is electrically coupled to a ground via the DC power supply input Vin. A connection point of the cathode of the clamp diode D61 and the first terminal of the clamp capacitor C61 is connected to a terminal of the resistance adjustment circuit 60, and the other terminal of the resistance adjustment circuit 60 is also connected to the positive terminal of the DC power supply input Vin of the Flyback power converter and is electrically coupled to a ground via the DC power supply input Vin.

As shown in the broken-line in FIG. 11, the resistance adjustment circuit 60 of the present application includes a second resistor R600, a first resistor R601, a switch element Q602 and a control circuit 603. A terminal of the first resistor R601 is connected to a connection point of the first terminal of the clamp capacitor C61 and a terminal of the second resistor R600, the other terminal of the first resistor R601 is connected to a first terminal of the switch element Q602, and a connection point of a second terminal of the switch element Q602 and the other terminal of the second resistor R600 is connected to the positive terminal of the DC power supply Vin of the Flyback power converter to form a charge leakage circuit of the clamp capacitor C61. The control circuit 603 is connected to a control terminal (i.e., a gate electrode) of the switch element Q602 via an isolation module 6031, so as to control the switch element Q602 according to the operation states (for example, the operating current) of the power converter, thereby changing the resistance value of the resistance adjustment circuit 60.

For example, the input voltage of the DC power supply input Vin of the Flyback power converter in FIG. 11 is 400V, and the output voltage of the output V₀ of the Flyback power converter is 12V. The resistance adjustment circuit 60 receives the output current (i.e., the operating current) of the Flyback power converter, outputs a control signal and transmits the signal to the control terminal of the switch element Q602 via a transformer (i.e., the isolation module 6031), to control the operation states of the switch element Q602, so as to adjust the resistance value of the resistance adjustment circuit 60. It should be pointed out that the resistance adjustment circuit 60 may also be realized by employing the resistance adjustment circuit network as shown in FIG. 7.

As shown in FIG. 11, when the Flyback power converter has a relatively light load, the clamp capacitor C60 only needs to be discharged through the second resistor R600, so as to reduce the loss of the clamp snubber circuit. When the Flyback power converter has a relatively heavy load, the switch element Q602 needs to be conducted, and the clamp capacitor C61 is discharged through the first resistor R600, the second resistor R601 and the switch element Q602, to suppress the peak voltage on the power switch S6. That is to say, when the output current (i.e., the operating current) of the Flyback power converter is larger than a certain reference current, the switch element Q602 is conducted to discharge the clamp capacitor C61, and when the output current of the Flyback power converter is less than the reference current, the switch element is turned off, and the clamp capacitor C61 is discharged only through the second resistor R600.

The loss caused by the energy consumed on the leakage resistor during the discharge of the clamp capacitor and the loss caused by the stable voltage of the clamp capacitor applied across the resistor are the main losses of the clamp snubber circuit, therefore, compared with the conventional RCD clamp snubber circuit, the improved clamp snubber circuit and the method of the present application may optimize the equivalent resistance value of the leakage resistor according to the operation states of the power converter, so that the peak voltage on a rectifying switch element serving as a power switch is suppressed and meanwhile the efficiency optimization of different loads of the power converter is taken consideration.

If the clamp snubber circuit and the method of the present application are applied in a resonant power converter, the resistance value of the resistance adjustment circuit may be changed according to the operating frequency of the power converter. For example, if the power converter is a LLC resonant power converter, when the operating frequency is larger than a certain reference frequency, the peak voltage on a power switch may be suppressed by reducing the resistance value of the resistance adjustment circuit, and when the operating frequency is less than or equal to the reference frequency, the resistance value of the resistance adjustment circuit is increased.

If the clamp snubber circuit and the method of the present application are applied in a circuit controlled by PWM, for example applied in power converter circuits such as PSFB, Flyback, Boost, Buck and Forward, the resistance value of the resistance adjustment circuit may be adjusted according to the operating current of the power converter. When the operating current is larger than a certain reference current, the peak voltage on a power switch may be suppressed by reducing the resistance value of the resistance adjustment circuit, and when the operating current is less than the reference current, the resistance value of the resistance adjustment is increased.

By the above circuits and methods of the present application, a resistance value of a leakage resistor in a charge leakage circuit is maximized in different operation states of a power converter, and meanwhile a peak voltage on a power switch is also taken into consideration, thereby a power switch with a relatively low withstanding voltage level is chosen and meanwhile the loss caused by the clamp snubber circuit is minimized, the efficiency of the power converter is increased and the cost of the power converter is reduced.

Although the present invention has been described with reference to typical embodiments, it should be understood that the terminologies herein are for illustration purposes rather than to limit the present invention. The present invention can be implemented in many specific embodiments without departing from the spirit and scope of the present invention, and thus it shall be appreciated that the above embodiments shall not be limited to any details described above, but shall be interpreted broadly within the spirit and scope defined by the appended claims. The appended claims intend to cover all the modifications and changes falling within the scope of the appended claims and equivalents thereof.

What is claimed is:

1. A clamp snubber circuit for reducing a value of a peak voltage on a power switch of a power converter, comprising:
a clamp switch;
a clamp capacitor having a first terminal electrically coupled to the power switch via the clamp switch, and a second terminal electrically coupled to a ground; and
at least one resistance adjustment circuit, each of which comprises:
a switch element having a first terminal electrically coupled to the first terminal of the clamp capacitor, a second terminal electrically coupled to the ground, and a control terminal; and
a control circuit configured to receive a detection parameter of the power converter and compare the detection parameter with a preset parameter and output a control signal to the control terminal of the switch element to adjust a resistance value of the resistance adjustment circuit.

2. The clamp snubber circuit according to claim 1, wherein the resistance adjustment circuit further comprises a first resistor having a first terminal electrically coupled to the first terminal of the clamp capacitor and having another terminal electrically coupled to the first terminal of the switch element.

3. The clamp snubber circuit according to claim 1, wherein the resistance adjustment circuit further comprises a second resistor having a first terminal electrically coupled to the first terminal of the clamp capacitor and having another terminal electrically coupled to the second terminal of the switch element.

4. The clamp snubber circuit according to claim 2, wherein the resistance adjustment circuit further comprises a second resistor having a first terminal electrically coupled to the first terminal of the clamp capacitor and having another terminal electrically coupled to the second terminal of the switch element.

5. The clamp snubber circuit according to claim 1, wherein the second terminal of the switch element is electrically coupled to the ground via a first power supply.

6. The clamp snubber circuit according to claim 5, wherein the first power supply is an output power supply of the power converter.

7. The clamp snubber circuit according to claim 1, wherein both of the second terminal of the switch element and the clamp capacitor are coupled to the ground via a second power supply.

8. The clamp snubber circuit according to claim 7, wherein the second power supply is a capacitor.

9. The clamp snubber circuit according to claim 1, wherein the detection parameter is an operating frequency, the preset parameter is a reference frequency, and when the operating frequency is larger than the reference frequency, the resistance value of the resistance adjustment circuit is reduced, and when the operating frequency is less than or equal to the reference frequency, the resistance value of the resistance adjustment circuit is increased.

10. The clamp snubber circuit according to claim 1, wherein the detection parameter is an operating current, the preset parameter is a reference current, and the control circuit is configured to reduce the resistance value of the resistance adjustment circuit when the operating current is larger than the reference current, and increase the resistance value of the resistance adjustment when the operating current is less than or equal to the reference current.

11. The clamp snubber circuit according to claim 1, wherein the control circuit comprises:
a reference signal adjustment module configured to receive the detection parameter, and compare the detection parameter with the preset parameter and output at least one reference voltage; and
a signal process module having a first input terminal connected to the first terminal of the clamp capacitor, a second input terminal connected to an output terminal of the reference signal adjustment module, and an output terminal electrically coupled to the control terminal of the switch element, and configured to output the control signal corresponding to the reference voltage.

12. The clamp snubber circuit according to claim 11, wherein the detection parameter is an operating frequency, the preset parameter is a reference frequency, and the reference signal adjustment module is configured to output a first reference voltage when the operating frequency is larger than the reference frequency, and output a second reference voltage when the operating frequency is less than or equal to the reference frequency, and the first reference voltage is less than the second reference voltage.

13. The clamp snubber circuit according to claim 11, wherein the detection parameter is an operating current, the preset parameter is a reference current, and the reference signal adjustment module is configured to output a first reference voltage when the operating current is larger than the reference current, and output a second reference voltage when the operating current is less than or equal to the reference current, and the first reference voltage is less than the second reference voltage.

14. The clamp snubber circuit according to claim 12, wherein the signal process module is configured to receive a voltage value of the clamp capacitor and the first reference voltage and output a first control signal to reduce the resistance value of the resistance adjustment, and receive the voltage value of the clamp capacitor and the second reference voltage and output a second control signal to increase the resistance value of the resistance adjustment circuit.

15. The clamp snubber circuit according to claim 13, wherein the signal process module is configured to receive a voltage value of the clamp capacitor and the first reference voltage and output a first control signal to reduce the resistance value of the resistance adjustment, and receive the voltage value of the clamp capacitor and the second reference voltage and output a second control signal to increase the resistance value of the resistance adjustment circuit.

16. The clamp snubber circuit according to claim 1, wherein the clamp snubber circuit comprises a first resistance adjustment circuit and a second resistance adjustment circuit which are connected in parallel.

17. The clamp snubber circuit according to claim 9, wherein the power converter is a resonant power converter.

18. The clamp snubber circuit according to claim 10, wherein the power converter is a PWM power converter.

19. The clamp snubber circuit according to claim 18, wherein the PWM power converter is any one of a PSFB power converter, a Flyback power converter, a Boost power converter, a Buck power converter and a Forward power converter.

20. A resistance adjustment method using a clamp snubber circuit according to claim 1, comprising:
receiving a detection parameter of the power converter;
comparing the detection parameter with a preset parameter and outputting a control signal; and
adjusting a resistance value of a resistance adjustment circuit according to the control signal.

21. The method according to claim 20, wherein the detection parameter is an operating frequency, the preset parameter is a reference frequency, and when the operating frequency is larger than the reference frequency, the resistance value of the resistance adjustment circuit is reduced, and when the operating frequency is less than or equal to the reference frequency, the resistance value of the resistance adjustment circuit is increased.

22. The method according to claim 20, wherein the detection parameter is an operating current, and the preset parameter is a reference current, and when the operating current is larger than the reference current, the resistance value of the resistance adjustment circuit is reduced, and when the operating current is less than or equal to the reference current, the resistance value of the resistance adjustment circuit is increased.
